(19) United States
(12) Patent Application Publication
(10) Pub. No.: US 2007/0124294 A1
(43) Pub. Date: May 31, 2007

(54) Search proxy device, communication system, and method for searching for information

(76) Inventors: Qian Sun, Shenzhen (CN); Xuefei Song, Shenzhen (CN); Linyi Tian, Shenzhen (CN); Yang Zhao, Shenzhen (CN); Hongqing Bao, Shenzhen (CN)

Correspondence Address: FISH & RICHARDSON PC, P.O. BOX 1022, MINNEAPOLIS, MN, 55440-1022, US

(21) Appl. No.: 11/604,544

(22) Filed: Nov. 27, 2006

(30) Foreign Application Priority Data
Nov. 25, 2005 (CN) 200510124148.7

(51) Int. Cl. G06F 17/30

(52) U.S. Cl. 707/3

(57) ABSTRACT

A search proxy device, a communication system and a method for searching for information are disclosed. The search proxy receives an Extensible Markup Language (XML) document information search request from a client or a service enabler server, processes the XML document information search request, sends a search message to a XML Document Management (XDM) server storing XML documents, and returns a search result from the XDM server to the client or the service enabler server.

### RELATED APPLICATIONS

Under 35 U.S.C. §119, this application claims the benefit of a foreign priority application filed in China, serial number 200510124148.7, filed Nov. 15, 2005.

### FIELD OF THE INVENTION

The present invention relates to communications technology, and more particularly to a search proxy device, a communication system, and a method for searching for information.

### BACKGROUND OF THE INVENTION

At present, a variety of service enablers in communication system, such as presence, Push-to-talk over Cellular (PoC), and Instant Messaging (IM), etc, have to access and manipulate some shared or respectively required information, such as Uniform Resource Identifier (URI) list, group, access control policy and authorization policy, etc. Such information is stored in XML Document Management (XDM) servers in Extensible Markup Language (XML). The service enablers access and manipulate the XML data using XML Configuration Access Protocol (XCAP).

Usually, each service enabler has a separate XDM server, which stores and manages XML data dedicated for the service enabler. A shared XDM server may also be provided to store and manage XML data as required for all service enablers. The service enabler servers may access directly the information in the XDM servers, and the client may also access and manipulate the XML data via an aggregation proxy device using XCAP. FIG. 1 shows a schematic diagram of a network in which a client accesses XDM servers via an aggregation proxy device. The aggregation proxy device is a junction point for the XDM client to access the XML documents in the XDM servers, and it mainly carries out authentication for the XDM client and routes XCAP requests to corresponding XDM servers. The operating principle of the aggregation proxy device is described in XDM V1.0 Specification released by Open Mobile Alliance (OMA) and XCAP protocol documentation released by Internet Enablerering Task Force (IETF).

In the network as shown in FIG. 1, the client may create, delete, modify, and get XML documents. The process of HTTP GET operation from the client to obtain an XML document is as follows:

1. An XDM client sends an XCAP request message containing XCAP command name (i.e., GET), AUID (i.e., unique ID of the XCAP application, e.g., resource-lists), and filename (i.e., fr.xml) to be obtained, etc., to obtain an XML document; specifically, the message may be:

GET/services/resource-lists/users/bill/fr.xml HTTP/1.1

2. Upon receiving the XCAP request message, the aggregation proxy device authenticates the user, and routes the request message to the corresponding XDM server after a successful authentication;

3. Upon receiving the request message, the XDM server searches for the corresponding XML document, and returns the XML document to the client with a return message as follows:

HTTP/1.1 200 OK
Etag: “hhwwe”
Content-Type: application/resource-lists+xml
<?xml version=“1.0” encoding=“UTF-8”?>
<resource-lists xmlns=“urn:ietf:params:xml:ns:resource-lists”>

<list name=“friends”>

<entry uri=“sip:sunqian@huawei.com”>

<display-name>Sun Qian</display-name>

</entry>

</list>

</resource-lists>

In the above HTTP GET process, the information of required elements or attributes of the XML document is specified in the XCAP request message. In applications, the user desires to obtain information that meets specified conditions in multiple XML documents in one operation, e.g., searches for group information containing its own URI, which is located in different XML documents); in addition, the information as required by the user may exist in XML documents in different XDM servers or even different service enabler servers; furthermore, sometimes the information as required by the user has to be obtained through complex searches, e.g., a combined search or an associated search, in which the information obtained from an XML document is used as a condition for searching in another XML document.

The above user requirements can't be implemented directly through the HTTP GET process; instead, they should be implemented by obtaining multiple XML documents related with target information from the XDM servers by the client for many times and performing an associated search on the client locally to obtain the target information. The network bandwidth is wasted and a large amount of unexpected information is transmitted; in many cases, the client can't determine which XML documents are related with the target information and thereby can't obtain those documents through the foresaid XML document obtaining process.

### SUMMARY OF THE INVENTION

Embodiments of the present invention provide a search proxy device, a communication system, and a method for searching for information in a communication system, so as to improve the XML document information search capability of a client in servers storing XML documents.

The present invention provides a search proxy device according to an embodiment of the present invention. The search proxy deivce receives an Extensible Markup Language (XML) document information search request from a client or a service enabler server, processing the XML document information search request, sending a search message to a XML Document Management (XDM) server storing XML documents, and returning a search result from the XDM server to the client or the service enabler server.

In an embodiment, the search proxy device includes:

an aggregation interface module, for receiving the XML document information search request from the client or from the service enabler server, forwarding the XML document information search request to a search interface module, and returning the search result received by a search interface module to the client via an aggregation proxy device;

the search interface module, for processing the XML document information search request, sending a search message to the XDM server corresponding to the XML document, and sending the search result from the server storing XML documents to the aggregation interface module.

In an embodiment, the search proxy device further includes:

an asynchronous module, for processing an asynchronous search request, sending an asynchronous search message to the search interface module, processing an asynchronous search result received by the search interface module, and sending a search result processed by the asynchronous module to a combination module.

In an embodiment, the search proxy device further includes:

the combination module, for combining the search results received from the search interface module or the asynchronous module, and sending the combined result to the aggregation interface module.

The present invention provides a communication system according to another embodiment of the present invention. The communication system includes:

a search proxy device, for receiving an Extensible Markup Language (XML) document information search request from a client or a service enabler server, processing the XML document information search request, forwarding a result processed by the search proxy device to a XML Document Management (XDM) server storing XML documents, and returning a search result received from the XDM server storing XML documents to the client or the service enabler server.

In an embodiment, the XML document information search request includes a real-time and/or an asynchronous XML document information search request.

In an embodiment, the search proxy device further combines the search results.

In an embodiment, the communication system further includes:

an aggregation proxy device, for receiving the XML document information search request, forwarding the XML document information search request to the search proxy device, and returning a search result to the client.

In an embodiment, the communication system further includes:

a presence subsystem, for receiving, storing and distributing presence information and authorization rule information of users.

In an embodiment, the XDM server creates the XML documents, performs authentication in accordance with the received XML document information search request.

In an embodiment, the communication system further includes at least one of the servers:

a shared list XDM server, for storing shared Uniform Resource Identifier (URI) list information including at least one of list name and URIs contained in the list, and providing the search proxy device with the stored URI list information;

a shared group XDM server, for storing shared group information including at least one of group URI, group member URI, group name and description, and group policy, and providing the search proxy device with the stored group information; and

a shared user profile XDM server, for storing shared user profiles including at least one of user URI, name, age, and gender information, and providing the search proxy device with the stored user information.

In an embodiment, the communication system further includes:

a presence server, for receiving, storing, and distributing user presence information comprising at least information on whether the users are online, and providing the search proxy device with the stored presence information; and

a presence XDM server, for storing authorization rule information of the users, which is accessed by the search proxy device and the presence server using XCAP protocol, or storing authorization rule information of the users, synchronizing the presence information in the presence server, and providing the search proxy device with the stored presence information.

In an embodiment, the communication system further includes:

a presence information XDM server, for storing presence information and authorization rule information of users.

In an embodiment, the XDM server storing XML documents includes at least one of an XDM server of service enabler, a shared list XDM server, a shared group XDM server, a shared user profile XDM server, a presence information XDM server, a presence server, and a presence XDM server.

The present invention provides a method for searching for information according to another embodiment of the present invention. The method for searching for information includes:

processing, by a search proxy device, an Extensible Markup Language (XML) document information search request received from a client or a service enabler server, routing and forwarding the XML document information search request to a XML Document Management (XDM) server storing XML documents;

receiving, by the search proxy device, a search result from the XDM server storing XML documents, and returning the search result to the client or the service enabler server.

In an embodiment, the process of processing, by a search proxy device, an Extensible Markup Language (XML) document information search request received from a client or a service enabler server, routing and forwarding the XML document information search request to a XML Document Management (XDM) server storing XML documents includes:

sending, by the client, a real-time and/or an asynchronous XML document information search request containing a unique ID of a search application and a search expression to an aggregation proxy device;

forwarding, by the aggregation proxy device, the XML document information search request to the search proxy device in accordance with the unique ID;

accessing, by the search proxy device, the XDM server storing XML documents in accordance with the search expression, obtaining authorization rule information to perform authentication, obtaining a list of XML documents which the user is authorized to retrieve or search in, and searching for XML document information meeting a condition in the list of XML documents.

In an embodiment, the process of receiving a search result from the server storing the XML documents comprises:

in accordance with the search request, searching for the XML document information in a list of XML documents that the user is authorized to retrieve or search in, and sending the search result to the search proxy device; and

combining the search result by the search proxy device.

In an embodiment, the process of searching for the XML document information in the list of XML documents that the user is authorized to retrieve or search in includes:

searching, a portion of the XML documents available to the user in accordance with the authorization rule of the XML documents included in the list that the user is authorized to retrieve or search in.

In an embodiment, the process of combining the search result by the search proxy device includes at least one of:

performing, by the search proxy device, operations including union and intersection on the search result; and

combining a next search result by the search proxy device, with the search result as a search condition for a next search.

In an embodiment, the process of combining a next search result by the search proxy device with the search result as a search condition for a next search further includes:

searching, by the search proxy device, in a presence server or a presence information XDM server in accordance with a Uniform Resource Identifier (URI) contained in the search result to obtain presence information of a Presentity corresponding to the URI, and combining the presence information and the search result.

In an embodiment, the method for searching for information further includes:

synchronizing, by the presence server, the presence information stored in the presence server to a presence information XDM server, and updating the presence information to the presence information XDM server using XML Configuration Access Protocol (XCAP) or Session Initiation Protocol (SIP) protocol when presence information in the presence server changes.

In an embodiment, the method for searching for information further includes:

upon receiving the search request from the search proxy device, obtaining by the presence information XDM server, presence information for the URI from a presence server through a FETCH operation.

In an embodiment, the method for searching for information further includes:

storing, by the search proxy device, the received asynchronous search request in an asynchronous module; and upon a predetermined time expires, sending the search request to the XDM server storing the XML documents periodically, till the client deletes the asynchronous search request; or storing a received asynchronous search result, comparing this search result with a search result at a next search, and sending a changed portion to the client.

In an embodiment, the method for searching for information further includes:

upon obtaining a list of XML documents, sending, by the search proxy device, a separate search request for each XML document included in the list, combining all search results obtained from the server storing XML documents, and returning the combined result to the client.

In an embodiment, the method for searching for information further includes:

receiving, by the search proxy device, the search request from the service enabler server to obtain the XML document information in the XDM server storing the XML documents; obtaining user service information in the service enablers from the service enabler servers and returning the user service information as a part of the search result to the client.

In an embodiment, the method for searching for information further includes:

synchronizing, by a shared user profile XDM server, the presence information of the user in the presence server; the presence information includes at least information on whether the user is online.

By providing a search proxy device in the communication system according to an embodiment of the present invention, the client is not limited to use HTTP GET mode to retrieve information in individual XML documents stored in servers. While, according to an embodiment of the present invention, the client can retrieve information from multiple XML documents stored in multiple XDM servers once and perform complex searches such as combined search. An embodiment of the present invention enhances the client's XML document information search capability in servers storing XML documents, and makes the search function more flexible and powerful.

### BRIEF DESCRIPTION OF THE DRAWINGS

FIG. 1 is a schematic diagram of a network in which a client accesses XDM servers via an aggregation proxy in the prior art;

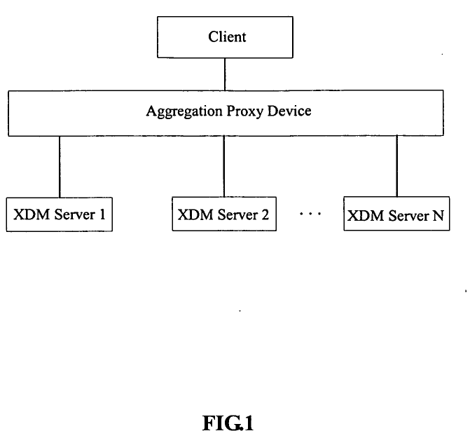

FIG. 2 is a structural diagram of the communication system according to an embodiment of the present invention;

FIG. 3 is a processing flowchart for searching for information in the communication system according to an embodiment of the present invention;

FIG. 4 is a schematic diagram of the network with the presence server and the presence XDM server in the prior art.

FIG. 5 is a schematic diagram of the network with the presence information XDM server, the presence server, and the presence XDM server in an embodiment of the present invention;

FIG. 6 is a flowchart of message interaction in an embodiment of the present invention;

FIG. 7 is a schematic diagram of the network in an embodiment of the present invention; and

FIG. 8 is a schematic diagram of the network in an embodiment of the present invention.

### DETAILED DESCRIPTION OF THE INVENTION

Some embodiments of the present invention provide a search proxy device, a communication system that utilizes the search proxy device, and a method for searching for information in the communication system by utilizing the search proxy device. According to an embodiment of the present invention, a search proxy device is provided to process search requests from the client forwarded by an aggregation proxy device or from a service enabler server, forward the processed search requests to an XDM server corresponding to an XML document, combine the search result from the XDM server, and return the combined search result to the service enabler server or to the client via the aggregation proxy device. In another case, the search proxy device may retrieve user service information from the service enabler server and return the retrieved user service information as the search result to the client; for example, the search proxy device may retrieve user presence information from a presence server.

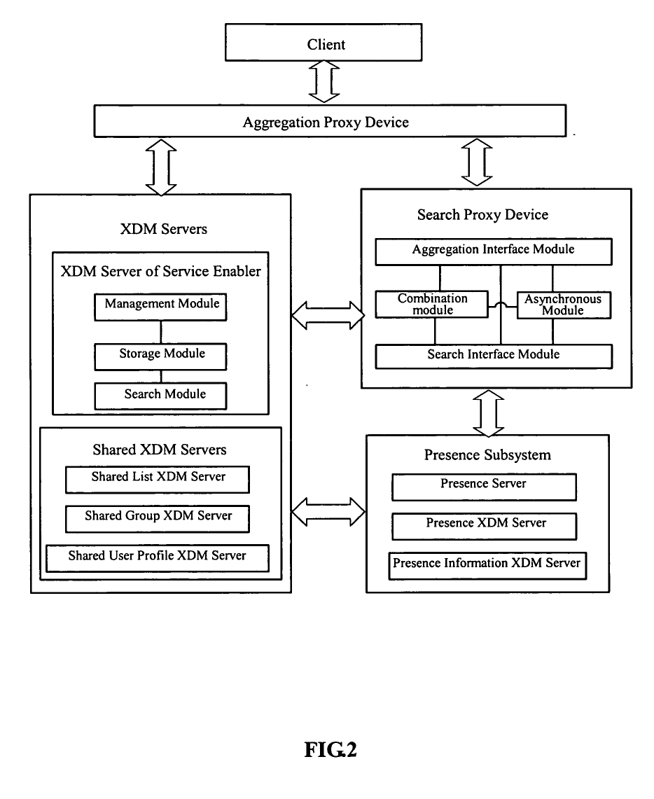

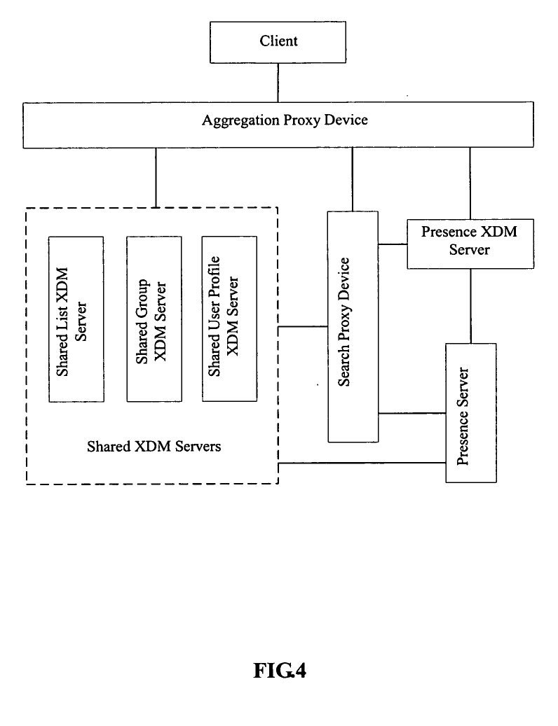

FIG. 2 depicts a structural diagram of the communication system according to an embodiment of the present invention. This diagram is merely an example, which should not unduly limit the scope of the claims. One of ordinary skill in the art would recognize many variations, alternatives, and modifications. As shown in FIG. 4, the communication system includes a client, an aggregation proxy device, an XDM server, a presence subsystem, and a search proxy device.

The search proxy device is adapted to receive real-time and/or asynchronous XML document information search requests from the client forwarded by the aggregation proxy device or from the service enabler server, process the real-time search request and/or the asynchronous search request, send a search message to the XDM server or a presence server in the presence subsystem, combine a response message from the XDM server or the presence server, and return the combined result to the client via the aggregation proxy device. The search proxy device includes: an aggregation interface module, a combination module, a search interface module, and an asynchronous module.

The aggregation interface module is adapted to receive real-time and/or asynchronous XML document information search requests from the client forwarded by the aggregation proxy device or from the service enabler server, forward the received real-time search request to the search interface module, forward the received asynchronous search request to the asynchronous module, and send the combined result from the combination module to the aggregation proxy device.

The asynchronous module is adapted to receive the asynchronous search request, store the received asynchronous search request, send an asynchronous search message to the search interface module, and forward the asynchronous search result from the search interface module to the combination module.

The search interface module is adapted to obtain authorization rules and send search response messages for the received real-time and/or asynchronous search message, send a search message to the XDM server or the presence server, forward the real-time search result from the XDM server or the presence server to the combination module to process, and transfer the real-time and/or asynchronous search result from the XDM server and the presence server to the asynchronous module.

The combination module is adapted to combine the search results received from the search interface module or the asynchronous module, and send the combined result to the aggregation interface module.

The process of combination is described as follows:

1. The combination module combines the search results in the response messages. The search results may be processed through a UNION operation or INTERSECTION operation. For example, the group information containing a specified URI obtained from the PoC group XDM server and the IM group XDM server may be processed respectively through a UNION operation by the combination module.

2. The combination module takes a current search result as a next search condition for the next search. For example, if the client wants to search for the user information of group member in a group with a specified URI, the client may obtain the information of the group with the specified URI and the URIs of the group members in the group from the XDM server that stores the group information, and search for the user information of group member with a specified URI in the XDM server that stores user information.

The aggregation interface module sends the combined search result to the client via the aggregation proxy device.

In addition, after receiving the returned asynchronous search result, the combination module stores the search result every time and compares it with the next search result, so that the combination module sends only the changed portion to the client via the aggregation proxy device.

The search proxy device may also obtain presence information of a Presentity corresponding to the URI from the presence server or the presence information XDM server in accordance with the URI of the user sending the search request, and combine the obtained presence information with the obtained search result, and return the combined result to the client.

The aggregation proxy device is adapted to receive a real-time or asynchronous XML document information search request from the client, forward the request to the search proxy device, and return a combined result from the search proxy device to the client. The client manages the XML documents stored in the XDM server through the aggregation proxy device.

The XDM server includes an XDM server of service enabler and a shared XDM server. The XDM server is adapted to store and manage XML documents for various services, authenticate the search message from the search proxy device, search the XML documents in accordance with the search message from the search proxy device, and return a search result to the search proxy device. The XDM server of service enabler includes a search module, a storage module, and a management module.

The management module is adapted to create XML documents corresponding to the services in accordance with XCAP operation requests from the client, transfer the created XML documents to the storage module, and modify, delete the XML documents stored in the storage module, etc.

The storage module is adapted to store the XML documents created by the management module and provide the search module with information of the stored XML documents.

The search module is adapted to receive the search message from the search proxy device, parse the search message, search for XML document information according to the received search message in the storage module, and return the search result to the search proxy device.

The shared XDM server is adapted to store and manage XML data shared by the various services. The shared XDM server includes: a shared list XDM server, a shared group XDM server, and a shared user profile XDM server. The shared user profile XDM server stores user information.

The shared list XDM server is adapted to store information of the shared URI list, which includes list name and URIs contained in the list. The shared group XDM server is adapted to store shared group information, the shared group information includes group URI, group member URI, group name and description, and group policy information. The shared group XDM server includes a PoC group XDM server and an IM group XDM server, etc. The shared user profile XDM server is adapted to store shared user profile, which includes user URI, name, age, and gender information, etc.

The presence subsystem includes a presence server, a presence XDM server, and a presence information XDM server. The presence server is adapted to receive, store, and distribute user presence information, including information on whether the user is online. The presence XDM server is adapted to store user authorization rule information. The presence information XDM server is adapted to store both user presence information and user authorization rule information, which may be obtained from the presence server and the presence XDM server through data synchronization.

The search proxy device may directly access the presence XDM server using XCAP protocol to obtain the user authorization rule information, determine the authority of the user who sent the search request, and search for the user's presence information in the presence server according to the user's authority.

The search proxy device may also directly access the presence information XDM server using XCAP protocol to obtain the user authorization rule and determine the authority of the user who sent the search request, and search for the user's presence information in the presence server according to the user's authority. Or, the search proxy device may access the presence information XDM server using XCAP protocol; the presence information XDM server authenticate the search request to determine the presence information that may be searched for, and return the search result to the search proxy device. Through the presence information XDM server, the inter-links are reduced, and the search efficiency may be improved, without adverse effect on the performance of the presence server and the presence XDM server.

The client is adapted to send a real-time or asynchronous XML document information search request to the aggregation proxy device and receive the processed results from the aggregation proxy device; in addition, the client may also send a request to the aggregation proxy device to manipulate the XML documents stored in the XDM server.

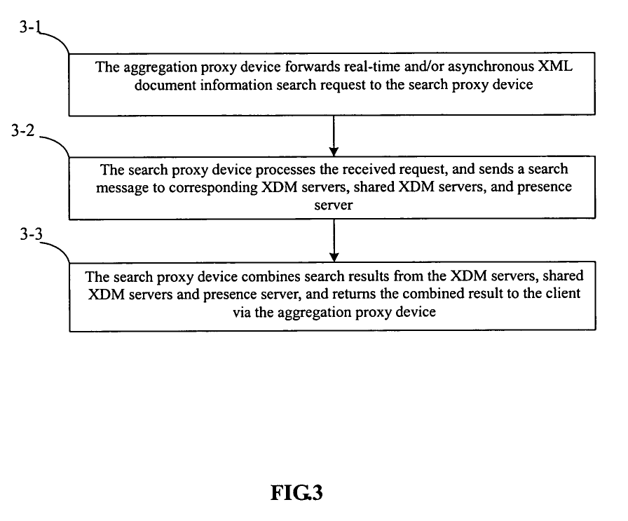

An embodiment of the present invention provides a method for searching for information in the above communication system; the processing procedure of the method is shown in FIG. 3:

In step 3-1, the aggregation proxy device forwards the real-time and/or asynchronous XML document information search request from the client to the search proxy device.

In the system according to an embodiment of the present invention, the client may send real-time and/or asynchronous XML document information search requests to the aggregation proxy device with HTTP POST method as required. The HTTP POST message body contains the unique identifier, AUID of the corresponding search application and the search expression.

To be consistent with the existing XCAP protocol processing, a unique identifier of the XCAP application (AUID, e.g., “SearchRequest”) is set in the search request; the XCAP message containing the AUID from the client are routed and forwarded to the search proxy device by the aggregation proxy device.

The aggregation proxy device forwards the received request to the search proxy device.

In step 3-2, the search proxy device processes the received request, and sends a search message to the XDM server of service enabler, shared XDM server, or presence server.

After receiving the real-time and/or asynchronous XML document information search request forwarded by the aggregation proxy device, the search proxy device processes the request accordingly.

Usually, each XML document corresponds to an authorization rule document, which records the operations authority (retrieve, search, modification, and deletion, etc.) for the XML document and information on which users may perform. The search proxy device may access the XDM server using XCAP protocol in accordance with the URI of the user who sent the search request, obtain the user's authorization rule information (i.e., obtain the information on the list of XML documents that the user is authorized to retrieve or search in), and create a search response message and send the response message to the XDM server corresponding to the XML document. Or, the XDM server may process the search request directly, i.e., authenticate the search request to determine whether the user is authorized to search and the information on the list of XML document that the user is authorized to retrieve or search in, and return the search result to the search proxy device. This may reduce interactions but requires the authentication function is available on the XDM server.

Since the asynchronous search may be performed at predetermined time (e.g., 1:00-4:00a.m.), the search results may be returned to the client at predetermined time. Therefore, the search proxy device may keep a received asynchronous search request in the asynchronous module and process the asynchronous search request periodically, till the client deletes the asynchronous search request.

In step 3-3, the search proxy device combines the search results returned from the XDM servers of service enabler, the shared XDM server, and/or the presence server that store XML document information, and returns the combined results to the client via the aggregation proxy device.

The XDM server of service enabler and the shared XDM server, and/or the presence server parse the search message in accordance with the received search message from the search proxy device, and search for the corresponding XML document information in the list of XML documents that the user is authorized to retrieve or search in.

If the authorization rule document for an XML document in the list of XML documents that the user is authorized to retrieve or search in is set to permit the user URI to retrieve, but only permit to retrieve or search in a portion of the XML document instead of in the whole XML document, then the XDM server should determine the portion the URI is authorized to retrieve in accordance with the authorization rule document information, and search for required information in the portion.

The XDM server of service enabler and the shared XDM server, and/or the presence server send the search result to the search proxy device through a response message; the search proxy device combine the search result.

Hereinafter three embodiments of the present invention are described.

Embodiment 1: the client searches for user profile and corresponding user presence information.

FIG. 4 shows a schematic diagram of the network with the presence server and the presence XDM server in the conventional art. As shown in FIG. 4, the conventional presence server operates on a basis of subscription and notification mechanism but doesn't provide any search mechanism. The conventional presence server is not an XCAP server, i.e., it doesn't provide any interface to access presence information using XCAP protocol. If the search proxy device requests to search for the presence information directly in the presence server, the search is implemented with a complex method, which will cause increased load on the presence server and increased complexity.

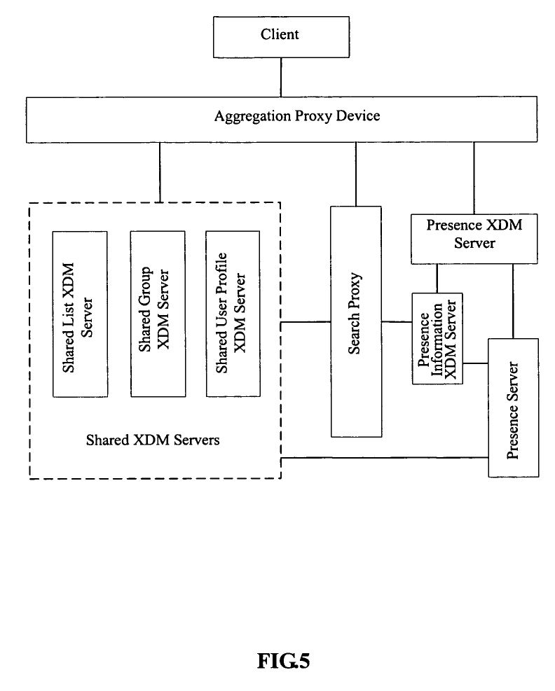

To solve the above problem, an embodiment of the present invention provides a presence information XDM server, in which the presence information and the user's authorization rule information are stored in synchronization, i.e., whenever the presence information in the presence server or the authorization rule information in the presence XDM server changes, the information in the presence information XDM server will be updated correspondingly at the same time. The presence server may synchronize the information to the presence information XDM server using XCAP or SIP protocol. A schematic diagram of the network with the presence information XDM server, the presence server, and the presence XDM server is shown in FIG. 5.

The specific search procedures in this embodiment are described as follows:

1. The client sends an HTTP POST search request to the aggregation proxy device. A search expression contained in the HTTP POST search request includes:

User profile conditions: “gender=female, city=Shenzhen, hobby=tennis ball”; and the request indicates the returned search result should include user profile such as user URI, nickname, etc., and presence information such as whether the user is online, etc.

2. The aggregation proxy device forwards the request to the search proxy device, which searches in the shared user profile XDM server for the information of XML documents meeting the user profile conditions in the search expression. An exemplary XML document containing user profile is shown as follows:

<?xml version=“1.0” encoding=“UTF-8”?>
<user-profile entity=“sunqian@msn.com”>

<nickname>Aaron</nickname>
<gender>male</gender>
<city>Shenzhen</city>
<hobby>tennis</hobby>
<e-mail>mailto:sunqian@huawei.com</e-mail>

</user-profile>

Usually, each XML document of user profile of each user stored in the shared user profile XDM server is accompanied with an authorization rule document, which defines the access authority of any other user to the user profile in the document (e.g., read, search, write, and modify, etc.); an exemplary authorization rule document is shown as follows:

<?xml version=“1.0” encoding=“UTF-8”?>
<ruleset entity=“sunqian@msn.com”>

<rule id=“1”>

<conditions><identity>

<domain domain=“msn.com”/>
</identity></conditions>

<actions>search</actions>
<transformations><provide-all-profile/></transformations>

</rule>

</ruleset>

A rule in the above authorization ruleset for “sunqian@msn.com” specifies all users in domain “msn.com” are granted with “search” authority in the search scope of “provide-all-profile”.

After receiving the search message from the search proxy device, the shared user profile XDM server obtains the list of XML documents of user profile that the URI of the user that sent the search request is authorized to retrieve or search in, and performs the search in the list in accordance with the conditions “gender=female, city=Shenzhen, hobby=tennis ball”, and returns the qualified user profiles (including user URI and nickname, etc.) to the search proxy device. In addition, it is unnecessary to return the information existing in the search conditions (e.g., gender).

The above method requires the shared user profile XDM server to process in accordance with the search conditions. If the search conditions are relatively complex, the performance of the XDM server may be affected, which may cause degraded response rate to other XDM servers operations. Here, another method may be used:

First, the search proxy device obtains the list of XML documents that the URI of the user that sent the search request is authorized to retrieve or search in from the XDM server; the search proxy device sends a separate search request to each XDM server storing the XML documents; finally, the search proxy device combines all search results obtained from the XDM server. The method requires the XDM server to perform simple searches for individual XML documents, i.e., the XDM server is only required to perform simple HTTP GET operations, and thereby brings little adverse effect on performance of the XDM server.

3. After obtaining the response message containing user profile, the search proxy device sends the search request containing the URI of the user who sent the search request as well as the URI corresponding to the user profile to the XDM server that stores presence information, e.g., the presence server or the presence information XDM server. The XDM server storing the presence information obtains the authorization rule for the URI corresponding to the user profile, determines whether the URI of the user who sent the search request is authorized to retrieve the presence information on online, STATUS, searches for the presence information for the authorized user, and returns the presence information on online to the search proxy device. The presence information in the presence information XDM server may be synchronized actively by the presence server, e.g., the presence server synchronizes the presence information to the XML documents in the presence information XDM server using XCAP protocol, or if the presence information XDM server has subscribed the presence information of users in the presence server using SIP protocol, the presence server sends the updated presence information to the presence information XDM server by means of a SIP notification message whenever the subscribed presence information is changed, then the presence information XDM server updates the presence information stored locally.

Or, the presence information XDM server may obtain the presence information from the presence server at the time of searching. The search proxy device sends the search request containing the user URIs which is authorized to obtain the presence information to the presence information XDM server; the presence information XDM server acts on behalf of the user who sent the search request to initiate a FETCH operation for these URIs to the presence server. The presence server authenticates the user who sent the search request in accordance with the authorization rules corresponding to the users' URIs in the search request, and returns a presence information NOTIFY message to the presence information XDM server. The presence information XDM server returns the presence information from the presence server to the search proxy device. The method conforms to the existing authentication mechanism and SIP subscription/notification mechanism for presence services and doesn't need modification to the presence server.

4. After combining the user profile and the presence information, the search proxy device returns the combined result to the client.

The combination method may be: loading the presence information and the searched XML document information to the search record corresponding to the same URI, as shown in the following table:

| | | XML document | presence |
|---|---|---|---|
| No. | URI | information | information |
| 1 | songxuefei@huawei.com | Nickname (snow), etc. | Online |
| 2 | wenx@sunline.cn | Nickname (apple), etc. | Offline |

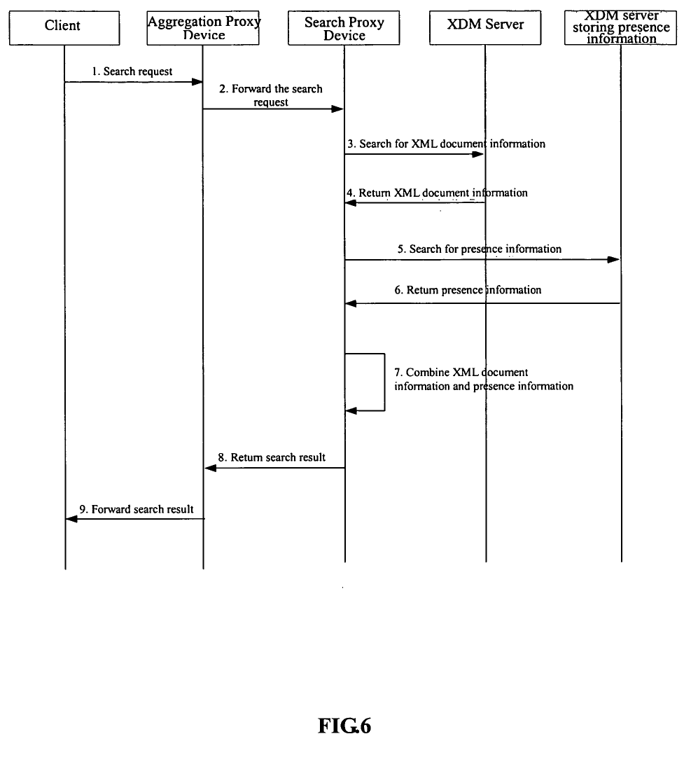

The flowchart of message interaction corresponding to embodiment 1 is shown in FIG. 6.

In addition, the presence information in the presence server may be synchronized directly by the shared user profile XDM server, which simplifies the implementation of searching for both user profile and presence information simultaneously. In this way, the search proxy device may obtain the user profile and the corresponding presence information from the shared user profile XDM server directly, instead of searching for the information in other servers. However, this is contradict to the design idea of providing the shared user profile XDM server to store simple static user profiles, and causes increased complexity.

There is a large amount of content of presence information in the presence server, including not only basic online status information but also information such as location, emotion, and actions, etc. Furthermore, not all users expect or are allowed to search for presence information; the presence server may choose to synchronize partial presence information of partial users instead of all presence information of all users to the shared user profile XDM server or the presence information XDM server in accordance with the user settings or system settings.

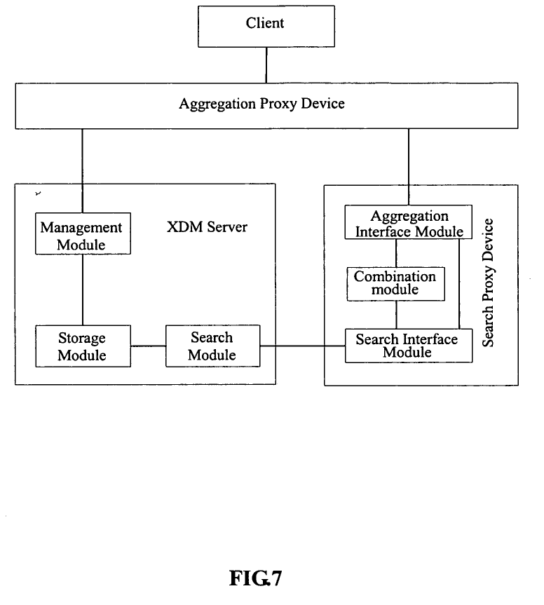

Embodiment 2 is described at module level. A schematic diagram of the network according to this embodiment is shown in FIG. 7.

Shared group information is stored in the XDM server and represented with the following XML document:

<?xml version=“1.0” encoding=“UTF-8”?>
<group>

<list-service uri=“sip:meetingroom-F1-7-A08@huawei.com”>

<display-name>regular meeting</display-name>

<subject> Application and Software Dept<subject>
<list>

<entry uri=“tel:13048907033”/>
<entry uri=“sip:sunqian@huawei.com”>

<display-name>Sun Qian</display-name>

</entry>

</list>

<ruleset><rule id=“1”>
<conditions><identity>
<domain domain=“huawei.com”/>
</identity></conditions>

<actions><search-handling>allow</search-handling></actions>

<transformations/>

</rule></ruleset>

</list-service>

</group>

The shared group information includes: group URI, display-name, subject, list (member list), URI information of the group members, and authorization ruleset; wherein, a rule in the authorization ruleset is configured to permit the users in the domain=“huawei.com” to search in the group. The rule specifying which URIs are permitted to search in the group may be also defined in a separate authorization rule document corresponding to the XML document.

The above group information is stored in the storage module in the XDM server. The client may manipulate the group information (e.g., add or delete group member URIs, modify and add authorization rule information, etc.) via the management module in the XDM server by means of XCAP operating instructions (retrieve, modify, etc.) sent from the aggregation proxy device.

For example, the client sends a request to search in the group, under an assumption that the search conditions include: subject containing characters of “Application and Software”, and the group information specified to be returned includes group URI and name, etc. When receiving the search request, the aggregation proxy device forwards the search request to the aggregation proxy device interface module of the search proxy device.

The aggregation interface module parses out the content of the search request (e.g., the requester's URI and the search expression, etc.,), and forwards the parsed result to the search interface module. The search interface module sends a search request to the shared group XDM server. When receiving the search request from the search interface module, the search module of the shared group XDM server obtains the XML documents that the requester's URI is authorized to retrieve or search in, and searches for the groups that meet the search conditions in the XML documents, and returns the information (e.g., group URI, group name, etc.) to the search interface module of the search proxy device. The search interface module forwards the search result to the client via the aggregation interface module and the aggregation proxy device.

If the groups searched by the client include groups in the XDM server of service enabler (e.g., PoC or IM), the search interface module may search for the information of groups meeting the conditions in the XDM server of the service enabler after obtaining the search result from the shared XDM server (or the search interface module may also search for the group information in each XDM server concurrently); after obtaining the search result from each XDM server, the search interface module forwards the search result to the combination module to process. After the search results are combined, the aggregation interface module forwards the combined result to the client via the aggregation proxy device.

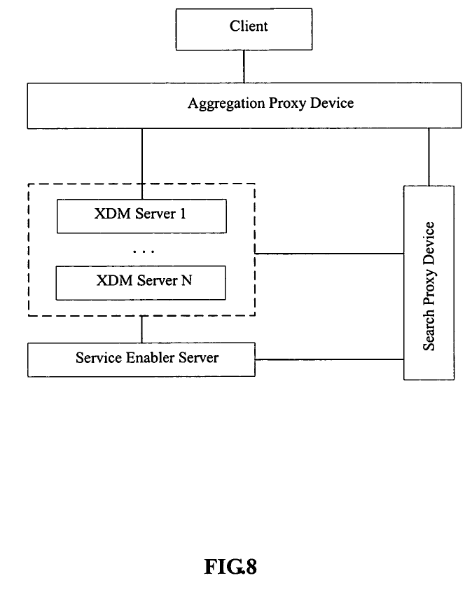

Embodiment 3: It describes the interaction between the service enabler server and the search proxy device. The schematic diagram of network according to this embodiment is shown in FIG. 8.

In an embodiment of the present invention, the service enabler server (e.g., presence, PoC, IM, or location service enabler servers) may send a search request to the search proxy device to obtain information of XML documents meeting the search conditions in the XDM server. Also, the search proxy device may also obtain service information related to the users in the service enablers from the service enabler server (e.g., obtain presence information from presence server, obtain location information from location server, etc.), and return the service information as a part of the search result to the client.

However, in the prior art, the service enabler server may modify, delete, and retrieve information of individual documents in the XDM server using XCAP protocol. Therefore, the service enablers described in the embodiments of the present invention support more complex service requests. For example, in the location service, the location server receives a location request, which specifies to obtain the locations of users who are of the specified gender and in the specified group as the requester; the location server sends the search request to the search proxy device to search for URIs of users of the specified gender and in the specified group as the requester; after the search proxy device receives the search request, it obtains the URIs of group members of the specified group in the XDM server storing the group information, and then obtains the user profiles of the group members in the XDM server storing user profiles, and returns the URIs of users of the specified gender to the location server, which in turn returns the user location information to the requester. Different to the case the client accesses the search proxy device, the service enabler servers may access the search proxy device directly instead of via the aggregation proxy device.

Preferred embodiments of the present invention are described as above. It should be appreciated that the protective scope of the present invention should not be limited to the embodiments. It is apparent to those skilled in the art to make various variations or equivalents without departing from the scope of the present invention. Therefore, the protective scope of the present invention should be determined as defined in the attached claims.

What is claimed is:

1. A search proxy device, for receiving an Extensible Markup Language (XML) document information search request from a client or a service enabler server, processing the XML document information search request, sending a search message to a XML Document Management (XDM) server storing XML documents, and returning a search result from the XDM server to the client or the service enabler server.

2. The search proxy device according to claim 1, comprising:
an aggregation interface module, for receiving the XML document information search request from the client or from the service enabler server, forwarding the XML document information search request to a search interface module, and returning the search result received by a search interface module to the client via an aggregation proxy device;
the search interface module, for processing the XML document information search request, sending a search message to the XDM server corresponding to the XML document, and sending the search result from the server storing XML documents to the aggregation interface module.

3. The search proxy device according to claim 2, further comprising:
an asynchronous module, for processing an asynchronous search request, sending an asynchronous search message to the search interface module, processing an asynchronous search result received by the search interface module, and sending a search result processed by the asynchronous module to a combination module.

4. The search proxy device according to claim 3, further comprising:
the combination module, for combining the search results received from the search interface module or the asynchronous module, and sending the combined result to the aggregation interface module.

5. A communication system, comprising:
a search proxy device, for receiving an Extensible Markup Language (XML) document information search request from a client or a service enabler server, processing the XML document information search request, forwarding a result processed by the search proxy device to a XML Document Management (XDM) server storing XML documents, and returning a search result received from the XDM server storing XML documents to the client or the service enabler server.

6. The communication system according to claim 5, wherein XML document information search request comprises a real-time and/or an asynchronous XML document information search request.

7. The communication system according to claim 5, wherein the search proxy device further combines the search results.

8. The communication system according to claim 5, further comprising:
an aggregation proxy device, for receiving the XML document information search request, forwarding the XML document information search request to the search proxy device, and returning a search result to the client.

9. The communication system according to claim 8, further comprising:
a presence subsystem, for receiving, storing and distributing presence information and authorization rule information of users.

10. The communication system according to claim 5, wherein the XDM server creates the XML documents, performs authentication in accordance with the received XML document information search request.

11. The communication system according to claim 8, further comprising at least one of the servers:
a shared list XDM server, for storing shared Uniform Resource Identifier (URI) list information comprising at least one of list name and URIs contained in the list, and providing the search proxy device with the stored URI list information;
a shared group XDM server, for storing shared group information comprising at least one of group URI, group member URI, group name and description, and group policy, and providing the search proxy device with the stored group information; and
a shared user profile XDM server, for storing shared user profiles comprising at least one of user URI, name, age, and gender information, and providing the search proxy device with the stored user information.

12. The communication system according to claim 8, further comprising:
a presence server, for receiving, storing, and distributing user presence information comprising at least information on whether the users are online, and providing the search proxy device with the stored presence information; and
a presence XDM server, for storing authorization rule information of the users, which is accessed by the search proxy device and the presence server using XCAP protocol, or storing authorization rule information of the users, synchronizing the presence information in the presence server, and providing the search proxy device with the stored presence information.

13. The communication system according to claim 8, further comprising:
a presence information XDM server, for storing presence information and authorization rule information of users.

14. The communication system according to claim 5, wherein the XDM server storing XML documents comprises at least one of an XDM server of service enabler, a shared list XDM server, a shared group XDM server, a shared user profile XDM server, a presence information XDM server, a presence server, and a presence XDM server.

15. A method for searching for information in a communication system comprising:
processing, by a search proxy device, an Extensible Markup Language (XML) document information search request received from a client or a service enabler server, routing and forwarding the XML document information search request to a XML Document Management (XDM) server storing XML documents;
receiving, by the search proxy device, a search result from the XDM server storing XML documents, and returning the search result to the client or the service enabler server.

16. The method according to claim 15, wherein the process of processing, by a search proxy device, an Extensible Markup Language (XML) document information search request received from a client or a service enabler server, routing and forwarding the XML document information search request to a XML Document Management (XDM) server storing XML documents comprises:
sending, by the client, a real-time and/or an asynchronous XML document information search request containing a unique ID of a search application and a search expression to an aggregation proxy device;
forwarding, by the aggregation proxy device, the XML document information search request to the search proxy device in accordance with the unique ID;
accessing, by the search proxy device, the XDM server storing XML documents in accordance with the search expression, obtaining authorization rule information to perform authentication, obtaining a list of XML documents which the user is authorized to retrieve or search in, and searching for XML document information meeting a condition in the list of XML documents.

17. The method according to claim 15, wherein the process of receiving a search result from the server storing the XML documents comprises:
in accordance with the search request, searching for the XML document information in a list of XML documents that the user is authorized to retrieve or search in, and sending the search result to the search proxy device; and
combining the search result by the search proxy device.

18. The method according to claim 17, wherein the process of searching for the XML document information in the list of XML documents that the user is authorized to retrieve or search in comprises:
searching, a portion of the XML documents available to the user in accordance with the authorization rule of the XML documents included in the list that the user is authorized to retrieve or search in.

19. The method according to claim 17, wherein the process of combining the search result by the search proxy device comprises at least one of:
performing, by the search proxy device, operations including union and intersection on the search result; and
combining a next search result by the search proxy device, with the search result as a search condition for a next search.

20. The method according to claim 19, wherein the process of combining a next search result by the search proxy device with the search result as a search condition for a next search further comprises:
searching, by the search proxy device, in a presence server or a presence information XDM server in accordance with a Uniform Resource Identifier (URI) contained in the search result to obtain presence information of a Presentity corresponding to the URI, and combining the presence information and the search result.

21. The method according to claim 20, further comprising:
synchronizing, by the presence server, the presence information stored in the presence server to a presence information XDM server, and updating the presence information to the presence information XDM server using XML Configuration Access Protocol (XCAP) or Session Initiation Protocol (SIP) protocol when presence information in the presence server changes.

22. The method according to claim 20, further comprising:
upon receiving the search request from the search proxy device, obtaining by the presence information XDM server, presence information for the URI from a presence server through a FETCH operation.

23. The method according to claim 15, further comprising:
storing, by the search proxy device, the received asynchronous search request in an asynchronous module; and upon a predetermined time expires, sending the search request to the XDM server storing the XML documents periodically, till the client deletes the asynchronous search request; or storing a received asynchronous search result, comparing this search result with a search result at a next search, and sending a changed portion to the client.

24. The method according to claim 14, further comprising:
upon obtaining a list of XML documents, sending, by the search proxy device, a separate search request for each XML document included in the list, combining all search results obtained from the server storing XML documents, and returning the combined result to the client.

25. The method according to claim 14, further comprising:
receiving, by the search proxy device, the search request from the service enabler server to obtain the XML document information in the XDM server storing the XML documents; obtaining user service information in the service enablers from the service enabler servers and returning the user service information as a part of the search result to the client.

26. The method according to claim 16, further comprising:
synchronizing, by a shared user profile XDM server, the presence information of the user in the presence server; the presence information comprises at least information on whether the user is online.
